(19) United States
(12) Patent Application Publication
(10) Pub. No.: US 2024/0399785 A1
(43) Pub. Date: Dec. 5, 2024

(54) PAINT ROLLER COVER CLEANING TOOL, PAINT STIRRER AND PAINT TIN OPENER -DESIGN AND METHOD OF USE

(71) Applicant: Brett Stanley, Otago (NZ)

(72) Inventor: Brett Stanley, Otago (NZ)

(21) Appl. No.: 18/702,491

(22) PCT Filed: Oct. 19, 2022
(86) PCT No.: PCT/NZ2022/000001

§ 371 Date: Apr. 18, 2024

(30) Foreign Application Priority Data
Oct. 19, 2021 (AU) 2021254535

(51) Int. Cl. B44D 3/00; B05C 17/02; B08B 1/16; B67B 7/14

(52) U.S. Cl. CPC B44D 3/006; B05C 17/0245; B08B 1/16; B67B 7/14

(57) ABSTRACT

A 3 in 1 painter's tool that improves the process of cleaning a paint roller cover by removing excess paint from the paint roller cover before cleaning with water or oil-based paint solvents. In addition, the 3 in 1 tool acts as a handy paint tin opener and stirring stick that gets into the corners of the tin.

The following statement is a full description of this disclosure, including the best method of use known to me:

### DESCRIPTION

### Field of Invention

The present disclosure relates to a tool that aids the removal of excess paint from a paint roller cover.

### Background

Cleaning of paint roller covers can be difficult and messy, and can require a large amount of water or solvents. The process of cleaning a paint roller cover also can lead to paint waste and environmental contamination.

The amount of residual paint on the roller cover directly contributes to the excess use of water or oil-based paint solvents, which can cause environmental contamination.

The more paint that can be removed from the roller cover and saved back into a paint tin not only saves money, but can also save water or solvent, and potential environmental contamination.

### SUMMARY OF INVENTION

The current disclosure provides a tool which easily removes paint from any paint roller sleeve or paint roller cover before a cleaning process. The tool comprises a blade cleaning element that comprises a first part that is curved so as to mimic the cylindrical shape of a cover of a paint roller, and a second part formed as a handle grip area to enable it to comfortably fit into a hand of a user for ease of use. Inventors know methods of removing paint from the paint roller cover with a straight blade of a putty knife or scraper only comes into contact with a very small area of the roller sleeve's circumference, making the task of scraping the paint out slow and laborious.

In contrast, by using a wiping action via the tool of the current disclosure, the user can remove more than 50%, preferably 77% of the paint left on the roller cover before cleaning, thereby reducing the amount of paint that would otherwise be flushed away and requiring less water or oil-based paint solvent cleaning fluids in a cleaning process. In addition, the tool can be used to stir paint and has a metal tip that can be used to open paint tins.

The tool of the current disclosure may be specifically shaped to fit just under half of a roller sleeve's circumference. This may allow the user to apply even pressure over a large area with each pass down the length of the sleeve. A putty knife or scraper will scrape the sleeve, pulling out fibres. The loose material ends up in the paint and in turn will end up on a freshly painted surface.

In contrast, the tool of the current disclosure may incorporate a working edge that is relatively gentle on most, and preferably all, roller sleeves, regardless of pile length or material, allowing longevity of the roller sleeve and a clean paint finish.

The tool may be manufactured from a plastics material such as polypropylene. The tool of the current disclosure is preferably made from a material or combination of materials that resistant to thinners and solvents, and so is relatively easy to clean. Preferably, the tool is made from 100% recycled materials, particularly 100% recycled plastic materials.

Ergonomically designed, the tool of the current disclosure may fit comfortably into the hand of the user for ease of use.

The tool of the current disclosure can also be used to open paint cans or tins and/or can be used to stir the paint in the paint tins to enable it to function as a 3 in 1 tool. The tool may therefore be provided with a paint lid engagement formation configured to engage the paint lid to lever the paint lid from the paint tin. The paint lid engagement formation may comprise a projection, such as a finger or lug or tip. The paint lid engagement formation may be provided at a distal end of the tool. The paint lid engagement formation may be provided at a handle portion of the tool. Preferably, the paint lid engagement formation is made of a mixed plastic materials used for the remaining parts of the tool.
*SAI Global tested

### DESCRIPTION OF DRAWINGS

The disclosure may be better understood with reference to the illustrations of embodiments of the disclosure which:

FIG. 1 illustrates an overall profile of a paint roller cleaning tool according to one embodiment;

FIG. 2 illustrates various views of the tool according to another embodiment;

FIG. 3 illustrates the usage of the tool for cleaning a paint roller according to another embodiment;

FIG. 4 illustrates the usage of the tool for stirring paint in a paint tin according to another embodiment; and

FIG. 5 illustrates the usage of the tool for opening a paint tin according to another embodiment.

### DETAILED DESCRIPTION

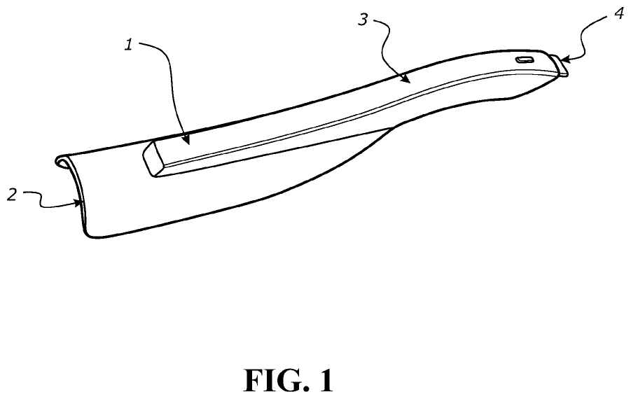

FIG. 1 shows an overall profile of the tool according to one embodiment of the current disclosure. The paint roller cleaning tool comprises a blade cleaning element 1 that includes a first part 2 that is curved so as to mimic the cylindrical shape of a cover of a paint roller, and a second part 3 formed as a handle grip area to enable it to comfortably fit into a hand of a user for ease of use.

In an example, the first part 2 is shaped so that the cross-section thereof along a direction vertical to the longitudinal axis of the tool mimics the cylindrical shape of the cover.

In another example, the first part 2 is shaped so that the cross-section thereof along the direction vertical to the longitudinal axis of the tool fits just under half of the circumference of the cover.

In another example, the first part 2 comprises a working edge which is configured to press gently on the cover in use, to an extent that excess paint can be removed from the cover efficiently while pulling out material from the cover is reduced or minimized.

In another example, the first part 2 and second part 3 of the tool is made from polypropylene.

In another example, the first part 2 and second part 3 are formed integrally as a single piece.

In another example, the second part 3 is ergonomically designed to be comfortably held providing good grip and leverage.

In another example, the tool further comprises a tip 4 attached to the second part 3 on the side opposite to the first part 2. The tip 4 can be used to open paint tins. Preferably, the tip 4 is a metal tip.

In another example, the blade cleaning element 1 has a curved end that is designed to mimic the cylindrical shape of a typical paint roller cover. On the other end of the blade cleaning element 1 the current disclosure has a metal tip 4 that can be used to open paint tins.

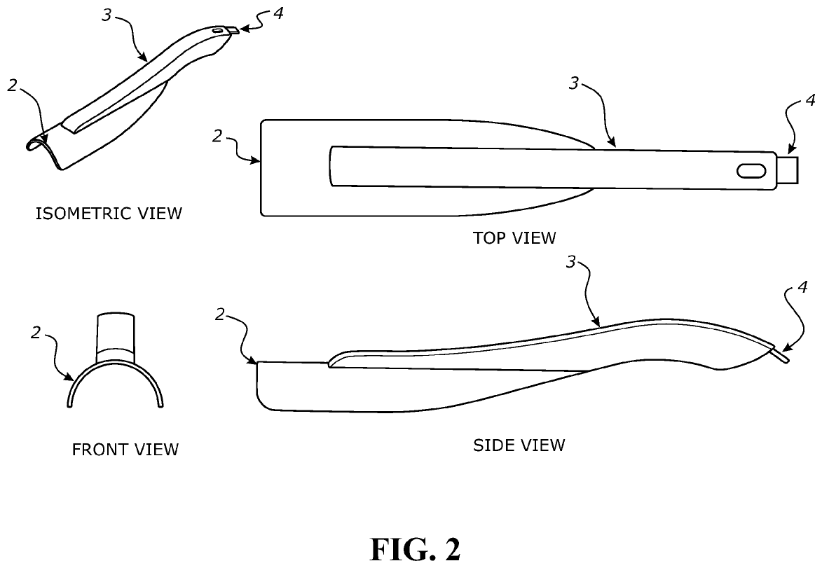

FIG. 2 shows various perspectives of the tool according to another embodiment of the current disclosure, including isometric view, top view, front view and side view, detailing the tool of FIG. 1, particularly the curved working edge of the first part 2, the second part or grip area 3 and the metal tip 4 used to open paint tins.

The tool is generally elongate. Preferably, the length of the tool is larger than 20 CM.

In another example, the first part 2 is generally elongate. Preferably, the length of the curved first part 2 is larger than 15 CM. As shown in the side view and isometric view, the curved working edge comprises an arc transition area between the edge along the longitudinal axis of the tool and the edge in the cross-section furthest from the second part 3 along the direction vertical to the longitudinal axis.

In another example, the first part 2 tapers toward the second part 3. Preferably, the diameter of the first part 2 ranges from 2 cm to 5 cm.

Preferably, the first part 1 tapers toward the second part 3 until the diameter became substantially the same as the width of the second part 3, as shown in top view, the side view and isometric view.

In another example, the second part 3 is generally elongate. Preferably, the length of the second part 3 is larger than 90 CM. Preferably, the cross section of the second part 3 along the direction vertical to the longitudinal axis is generally rectangular. Preferably, the width of the second part 3 is less than 2 CM.

Preferably, the second part 3 is hollow and open as also shown in FIG. 5 on the side opposite to the surface contacting the palm upon cleaning the roller cover. As shown in FIG. 5, there are plural of reinforcing plates arranged within the hollow second part 3 extending in the direction vertical to the longitudinal axis.

Preferably, the second part 3 is convex in the part fitting in use the hand of the user, in a direction opposite to the direction which the first part 2 is curved toward, as shown in the side view. Preferably, the convex part has an arc shape.

In another example, the tip 4 is flat and extends in a direction tangent to the external surface of the second part 3 contacting the palm upon cleaning the roller cover as shown in the side view. Preferably, the width of the tip 4 is less than that of the second part 3.

Preferably, the tip 4 are attached to the second part 3 by injection molding.

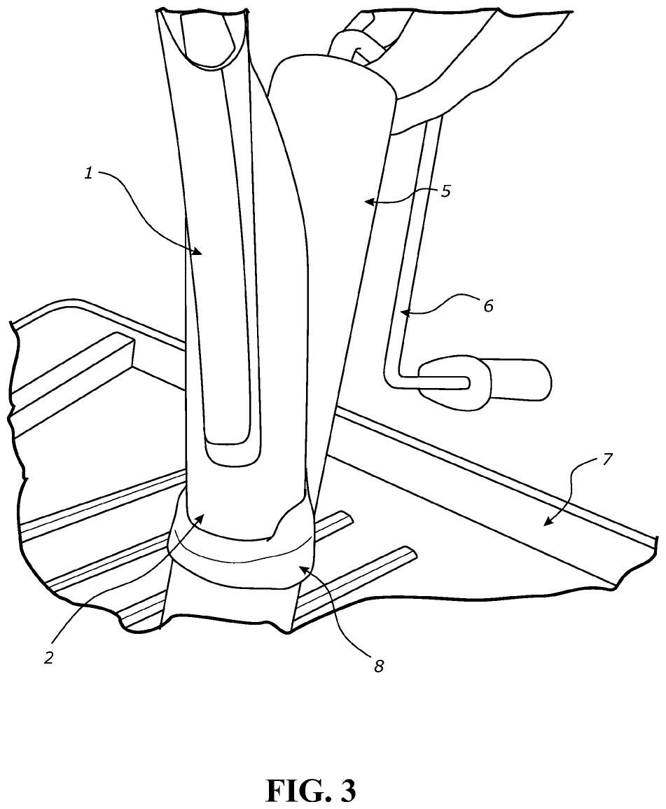

FIG. 3 illustrates the usage of the tool for cleaning a paint roller according to another embodiment. With one hand, the user holds the roller by the handle 6 positioning it above a paint tray 7.

Next, the user applies the blade cleaning element 1 to the cover at an angle between the longitudinal axis of the first part 2 and that of the roller. As shown in FIG. 3, with the other hand, the user grips the tool by the grip area 3 and applies the first part 2 to the cover. Preferably, the angle the blade cleaning element 1 is applied to the cover reduces the amount of friction to the fibres of the cover. The angle may range from 10 to 45 degrees.

Then, and the user in a firm downward action, squeezes the excess paint 8 from the roller cover to be collected back in the paint tray 7. Last, the user rotates the roller and repeats the above cycle until a desired amount of excess paint has been removed from the roller. According to experiment by the inventor, up to 77% of the excess paint can be removed from the roller cover.

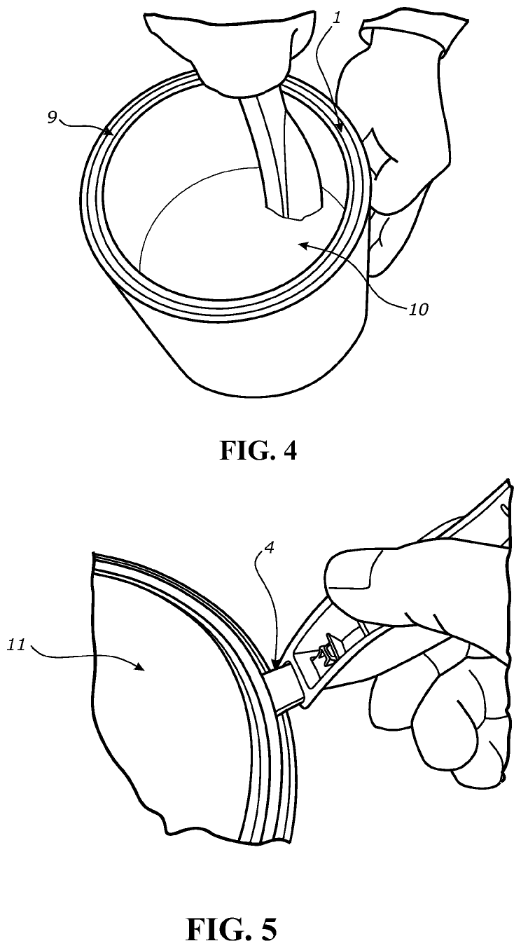

FIG. 4 shows the blade cleaning element 1 used to stir paint in a paint tin 9. With one hand, the user holds the tool by the grip area 3, preferably with the working edge facing toward the wall of the paint tin. Then the user positions it into the paint tin 9 to reach different corners or bottom and stirs the paint in any desired direction.

FIG. 5 shows the tool used to open a paint tin. The tip 4 is placed under the rim of the lid 11 of the paint tin, preferably with the working edge tilting toward upwards, and leveraged downwards to release the lid 11.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this disclosure has been described by way of example and with reference to possible embodiments thereof, it is to be understood that combinations, modifications or improvements may be made thereto without departing from the scope of the disclosure. The disclosure may also be said broadly to consist in the parts, elements and features referred to or indicated in the specification of the application, individually or collectively, in any or all combinations of two or more of said parts, elements or features.

Reference to any prior art in this specification is not, and should not be taken as, an acknowledgement or any form of suggestion that that prior art forms part of the common general knowledge in the field of endeavour in any country in the world.

1. A paint roller cleaning tool, comprising a blade cleaning element that comprises a first part that is curved so as to mimic the cylindrical shape of a cover of a paint roller, and a second part formed as a handle grip area to enable it to comfortably fit into a hand of a user for ease of use.

2. The paint roller cleaning tool according to claim 1, wherein the first part is shaped so that the cross-section thereof along a direction vertical to the longitudinal axis of the tool mimics the cylindrical shape of the cover.

3. The paint roller cleaning tool according to claim 1, wherein the first part is shaped so that the cross-section thereof along a direction vertical to the longitudinal axis of the tool fits just under half of the circumference of the cover.

4. The paint roller cleaning tool according to claim 1, wherein the first part comprises a working edge which is configured to press gently on the cover in use, to an extent that excess paint can be removed from the cover efficiently while pulling out material from the cover is reduced.

5. The paint roller cleaning tool according to claim 4, wherein the working edge comprises an arc transition area between the edge along the longitudinal axis of the tool and the edge in the cross-section furthest from the second part along the direction vertical to the longitudinal axis.

6. The paint roller cleaning tool according to claim 1, wherein the first part tapers toward the second part.

7. The paint roller cleaning tool according to claim 1, wherein the diameter of the first part ranges from 2 cm to 5 cm.

8. The paint roller cleaning tool according to claim 1, wherein the first part tapers toward the second part until the diameter is substantially the same as the width of the second part.

9. The paint roller cleaning tool according to claim 1, wherein the tool is made from polypropylene.

10. The paint roller cleaning tool according to claim 1, wherein the second part is ergonomically designed.

11. The paint roller cleaning tool according to claim 1, wherein the first part and second part are formed integrally as a single piece.

12. The paint roller cleaning tool according to claim 1, wherein the second part is convex in the part fitting into the hand of the user, in a direction opposite to a direction which the first part is curved toward.

13. The paint roller cleaning tool according to claim 1, wherein the tool further comprises a tip attached to the second part on a side opposite to the first part.

14. The paint roller cleaning tool according to claim 1, wherein the tip is a metal tip.

15. A method of cleaning a paint roller using the paint roller cleaning tool according to claim 1, comprising:
holding the paint roller by the user above a paint tray;
applying the blade cleaning element to the cover at an angle between the longitudinal axis of the first part and that of the roller;
squeezing paint in a downward motion so as to move excess paint down the cover so that the paint is able to flow back into the paint tray;
rotating the roller cover and
repeating the above process.

16. The method according to claim 15, wherein the angle the blade cleaning element is applied to the cover reduces the amount of friction to the fibres of the cover.

17. The method according to claim 15, wherein the angle ranges from 10 to 45 degrees.

18. The method according to claim 15, wherein the method further comprises after substantially no more paint can be squeezed out of the cover, rinsing the cover with water or paint thinners.

19. Usage of the paint roller cleaning tool of claim 1 as a paint stirrer to reach to the corners of a paint tin.

20. Usage of the paint roller cleaning tool of claim 13 as a tin opener to open paint tins.
